(19) United States
(12) Patent Application Publication
(10) Pub. No.: US 2020/0254593 A1
(43) Pub. Date: Aug. 13, 2020

(54) PNEUMATIC BIT DRIVER

(71) Applicant: SP Air Kabushiki Kaisha, Nagano (JP)

(72) Inventors: Tatsuya Hayashi, Nagano (JP); Kenneth J. Kober, Grove City, OH (US)

(21) Appl. No.: 16/270,283

(22) Filed: Feb. 7, 2019

(51) Int. Cl. B25B 21/00

(52) U.S. Cl. CPC B25B 21/004; B25B 21/002

(57) ABSTRACT

A hand-held power tool for driving bits. The tool includes a forward housing having a port extending through a lower surface to a hollow interior. The tool includes a motor having an output shaft rotating about a rotor axis in response to air passing through the motor. The tool has a carrier member mounted in the hollow interior of the forward housing for rotation about a turning axis extending generally transverse to the rotor axis. The carrier member has a bottom surface and a bit receiver opening aligned with the forward housing port. The bottom surface of the carrier member is flush with the lower surface of the forward housing. The tool includes a pinned linkage connecting the output shaft of the motor to the carrier member to rotate the carrier member about the turning axis as the output shaft of the motor rotates about the rotor axis.

### BACKGROUND

The present invention generally relates to hand-held power tools, and more particularly to a hand-held, pneumatically powered, ratchet bit driver.

Hand-held, pneumatically powered, ratcheting bit drivers are used to turn selected conventional bits, such as a ¼ inch hex bit having a Phillips head driver at an end opposite an end having a hexagonal cross section. The end having the hexagonal cross section fits in a hexagonal bit receiver opening in the head of the tool. The tool turns the bit receiver to drive the bit. Although pneumatically powered bit drivers exist, many have a bulky heads. For example, some pneumatic bit drivers have bevel gears in their heads to change the direction of the axis of rotation of the bit receiver to be transverse to the axis of rotation of the motor. The resulting bit driver head is relatively tall to accommodate the bevel gear transmission inside the head. These tall bit driver heads limit the usefulness of the bit driver because the heads do not fit in work spaces having low clearances.

Although other pneumatic bit driver configurations have shorter head profiles, many of these configurations include bit receivers that protrude outward from the head. Many of these bit drivers having protruding bit receivers also fail to provide sufficiently low head profiles to permit their use in many low clearance work spaces. Some of these bit drivers also have designs that permit debris to enter the head, potentially damaging or wearing internal components, and that permit lubricant to exit the head, leaking on surrounding areas potentially causing dirt to collect on those areas.

Thus, there exists a need for a durable pneumatic bit driver having a low profile head and a sealed head that prevents ingress of foreign debris and lubricant leakage.

### SUMMARY

In one aspect, the present disclosure includes a hand-held power tool for driving bits. The tool comprises a body including a forward housing and a rearward housing. The forward housing has a lower surface, a hollow interior, and a port extending through the lower surface to the hollow interior. The tool also includes a motor mounted in the rearward housing. The motor has an output shaft rotating about a central rotor axis in response to air passing through the motor. In addition, the tool includes a carrier member rotatably mounted in the hollow interior of the forward housing for rotation about a central turning axis extending generally transverse to the central rotor axis. The carrier member has a bottom surface and a bit receiver opening adapted for releasably receiving bits extending upward along the central turning axis into the carrier member from the bottom surface. The bit receiver opening is aligned with the forward housing port and the bottom surface of the carrier member is flush with the lower surface of the forward housing. Further, the tool includes a pinned linkage operatively connecting the output shaft of the motor to the carrier member to rotate the carrier member about the central turning axis as the output shaft of the motor rotates about the central rotor axis in response to air passing through the motor.

In another aspect, the disclosure describes a hand-held power tool for driving bits comprising a body including a forward housing and a rearward housing. The forward housing has a lower surface, a hollow interior, and a port extending through the lower surface to the hollow interior. The tool also includes a motor mounted in the rearward housing and having an output shaft rotating about a central rotor axis in response to air passing through the motor. In addition, the tool has a carrier member rotatably mounted in the hollow interior of the forward housing for rotation about a central turning axis extending generally transverse to the central rotor axis. The carrier member has ratchet teeth formed around an outward facing surface, a bottom surface and a bit receiver opening adapted for releasably receiving bits extending upward along the central turning axis into the carrier member from the bottom surface. The bit receiver opening is aligned with the forward housing port. The tool has a reciprocating pawl including a rack that engages the ratchet teeth on the carrier member to rotate the carrier member about the central turning axis as the pawl moves forward.

In yet another aspect, the disclosure includes a hand-held power tool for driving bits having a body including a forward housing and a rearward housing. The forward housing has a lower surface, a hollow interior, and a port extending through the lower surface to the hollow interior. Further, the tool includes a motor mounted in the rearward housing and having an output shaft rotating about a central rotor axis in response to air passing through the motor. The tool also includes a crank rotatably mounted in the body and operatively connected to the motor output shaft. The crank has an arm that orbits the central rotor axis as the output shaft rotates and a rocker element pivotally mounted in the hollow interior of the forward housing. The rocker element is operatively connected to the crank so the rocker oscillates in the hollow interior of the forward housing as the arm of the crank orbits the central rotor axis. In addition, the tool comprises an elongated pawl pinned to the rocker element, so the pawl reciprocates in a generally lengthwise direction as the rocker element oscillates in the hollow interior of the forward housing and a carrier member rotatably mounted in the hollow interior of the forward housing for rotation about a central turning axis extending generally transverse to the central rotor axis. The carrier member has a bottom surface and a bit receiver opening adapted for releasably receiving bits extending upward along the central turning axis into the carrier member from the bottom surface. The bit receiver opening is aligned with the forward housing port. The reciprocating pawl engages the carrier member to rotate the carrier member as the pawl reciprocates.

Other aspects of the present disclosure will be apparent in view of the following description and claims.

### BRIEF DESCRIPTION OF THE DRAWINGS

FIG. 1 is a cross section of a described ratchet bit driver;

FIG. 2 is an enlarged fragmentary detail of FIG. 1 broken away to show a pawl rack and a cam shaft lobe;

FIG. 3 is a cross section taken along line 3-3 of FIG. 2;

FIG. 4 is a perspective of a linkage inside the ratchet bit driver;

FIGS. 5A and 5B are bottom plans of a linkage and carrier member at opposite extremes of cyclic motion;

FIG. 6 is a cross section of a carrier member of the ratchet bit driver;

FIG. 7 is a bottom plan of the carrier member;

FIG. 8 is a top plan of the carrier member;

FIG. 9 is a top plan of an annular shoe of the ratchet bit driver;

FIG. 10 is a side elevation of a pusher pin for contacting the shoe;

FIG. 11 is a side elevation of an exemplary conventional bit for use with the ratchet bit driver;

FIG. 12 is a top plan of a split ring retainer of the ratchet bit driver.

Corresponding reference characters indicate corresponding parts throughout the drawings.

### DETAILED DESCRIPTION OF THE DRAWINGS

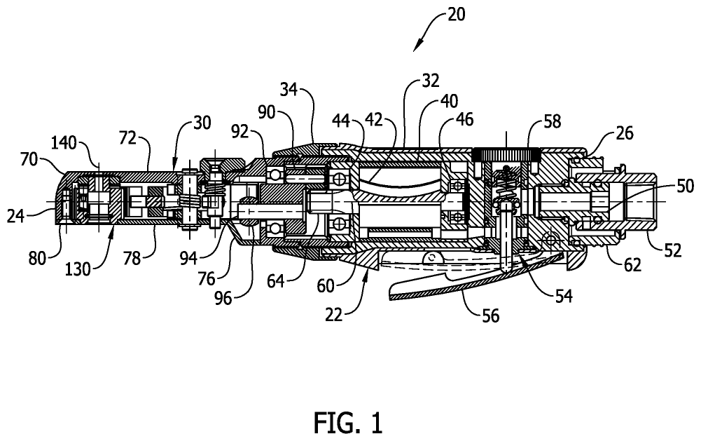

Referring to the drawings, and more particularly to FIG. 1, a pneumatically driven, ratcheting, bit driver is generally designated in its entirety by the reference number 20. The pneumatically driven, ratcheting, bit driver 20 will alternatively be referred to as a pneumatic bit driver, a hex bit driver, or, more broadly, a tool. The tool 20 has an elongated body or housing, generally designated by 22, including a forward or front end 24 and a rearward or back end 26. As illustrated in FIG. 1, the body 22 is formed in two pieces, a forward housing or head, generally designated by 30, and a rearward housing or motor housing 32, that are joined by a coupling 34. The motor housing 32 is generally cylindrical and sized for being received in and gripped by a user's hand. The head 30 has a flattened profile, permitting greater access to tighter workspaces when the tool 20 is in use. Although the head 30 may have other dimensions, the illustrated example has a height of less than about ¼ inch.

The motor housing 32 houses a motor 40 having a rotor 42 rotatably supported between axially spaced forward and rearward bearings 44, 46, respectively. An inlet 50 at the back end 26 of the motor housing 32 has a conventional fitting 52 for connecting the tool 20 to a hose (not shown) supplied with pressurized shop air. A valve assembly, generally designated by 54, is positioned between the inlet 50 and the motor 40. A lever 56 pivotally connected to the motor housing 32 provides leverage for selectively opening the valve assembly 54 to permit air to travel from the inlet 50 to the motor 40. Further, a knob 58 on the valve assembly 54 permits the assembly to be rotated to selectively regulate the volume and pressure of air passing through the valve assembly. Air traveling through the valve assembly 54 enters the motor 40 and spins the rotor 42 about its central rotor axis 60. Air exiting the motor 40 travels rearward through a series of passages (not shown) to an exhaust sleeve 62 surrounding the inlet fitting 52. The exhaust sleeve 62 is rotatable about the fitting 52 to selectively direct air exiting the motor housing 32. A splined output shaft 64 is formed on a forward end of the rotor 42 and protrudes from a forward end of the motor housing 32.

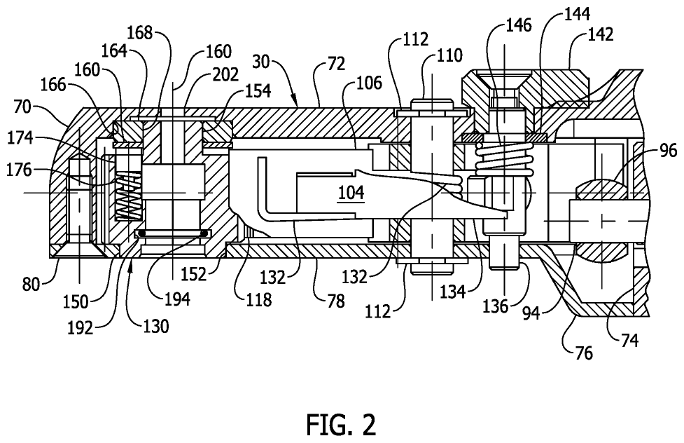

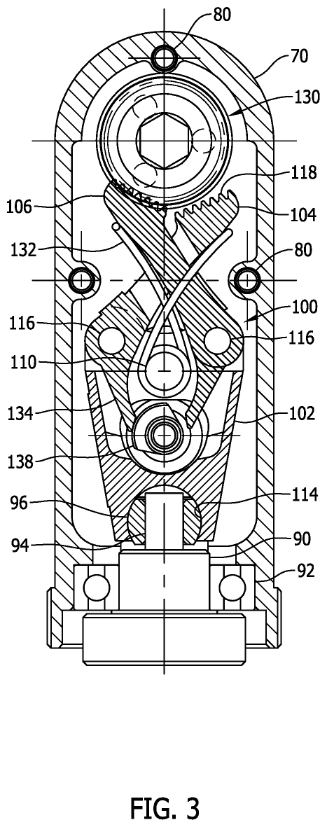

As illustrated in FIG. 2, the head 30 comprises a shell 70 having a planar upper surface 72 opposite a lower access opening 74 covered by a cover plate 76 forming a planar lower surface 78 of the head. Together, the shell 70 and plate 76 define a hollow interior. The plate 76 is connected to the shell 70 by screw fasteners 80. As shown in FIG. 1, a crank 90 is rotatably mounted in a bearing 92 positioned inside the shell 70. The output shaft 64 (FIG. 1) of the rotor 42 engages the crank 90 to rotate the crank inside the shell 70 as the rotor spins about its axis 60. As shown in FIGS. 1 and 3, the crank 90 has an eccentric arm 94 that orbits about the central rotor axis 60 as the crank turns in response to the motor 40 turning the output shaft 64 of the rotor 42. A spherical bushing 96 is provided on the eccentric arm 94 of the crank 90.

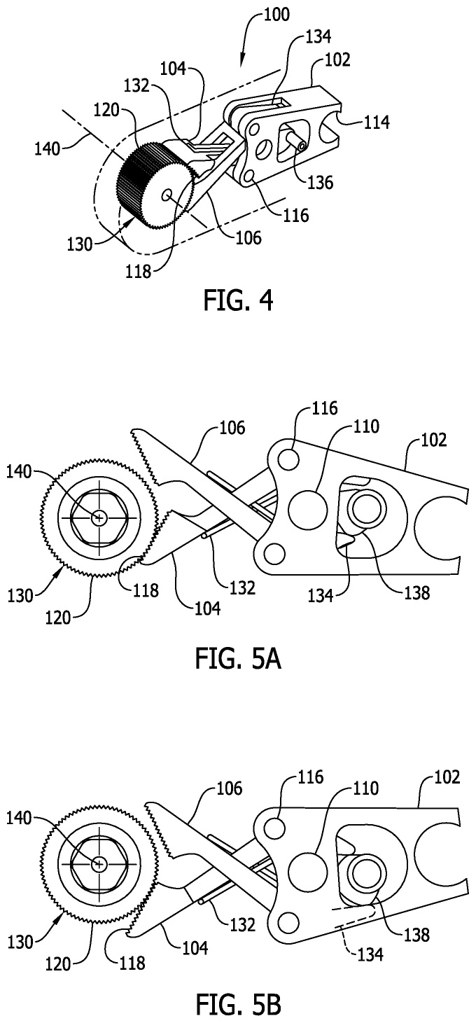

As shown in FIGS. 3 and 4, a pinned linkage, generally designated by 100, is located in the head 30 in front of the crank 90. The linkage 100 generally comprises a rocker element 102 and a pair of pawls 104, 106. The rocker element 102 is pivotally mounted on a post 110 extending through the head 30 between the shell 70 and the plate 76. The post 110 is held in position by retaining rings 112 (FIG. 2) fastened to opposite ends of the post. A cylindrical receptacle 114 formed at a rearward end of the rocker element 102 receives the spherical bushing 96 mounted on the eccentric arm 94 of the crank 90 as shown in FIG. 3, so the rocker element cyclically pivots or oscillates about the post 110 as the arm of the crank orbits about the rotor axis 60. A pin 116 pivotally connects each pawl 104, 106 to a corresponding opposite side of the rocker element 102 so each pawl reciprocates generally forward and backward in its respective lengthwise direction as the rocker element pivots on the post 110. As further shown in FIG. 4, a rack 118 is formed at the forward end of each pawl 104, 106 for intermittently engaging ratchet teeth 120 formed around a generally circumferential, outward facing, outer rim surface of a circular carrier wheel or carrier member, generally designated by 130, mounted in the head 30 between the shell 70 and the plate 76 as will be described in further detail. A torsion spring 132 surrounding the post 110 biases the rack 118 of each pawl 104, 106 toward the carrier wheel 130. Each pawl 104, 106 has a rearwardly extending finger 134. A cam shaft 136 positioned between the opposing fingers 134 of the pawls 104, 106 extends between the shell 70 and plate 76. The cam shaft 136 pivots to align a lobe 138 (FIG. 5A) on the cam shaft with a selected finger 134 of a pawl to determine whether the linkage turns the carrier wheel 130 clockwise or counterclockwise.

FIGS. 5A and 5B illustrate the linkage 100 and carrier wheel 130 when the rocker element 102 is positioned at opposite extremes of its cyclic pivoting motion while the lobe 138 of the cam shaft 136 is aligned with the finger 134 of pawl 106. When the lobe 138 engages the finger 134 of pawl 106, the rack 118 of pawl 106 is rotated away from the carrier wheel against the biasing force of the torsion spring 132 throughout the entire motion of the rocker element 102. Thus, the rack 118 of pawl 106 is separated from ratchet teeth 120 of the carrier member 130. The torsion spring 132 continues to bias pawl 104 toward a central turning axis 140 of the carrier wheel 130. At a start of each cycle, the rack 118 of pawl 104 engages the ratchet teeth 120 of the carrier wheel as shown in FIG. 5A. As the rocker element 102 pivots about the post 110 toward the position shown FIG. 5B, pawl 104 travels forward, driving the carrier wheel 130 to rotate clockwise as shown (or counterclockwise when viewed from above the head 30). As the rocker element 102 returns from the position shown in FIG. 5B to that shown in FIG. 5A, the pawl 104 travels rearward. The configurations and relative orientations of the ratchet teeth 120 and the rack 118 of pawl 104 force the rack away from the central axis 140 of the carrier member 130 against the biasing force of the torsion spring 132 causing the rack to slide over the ratchet teeth and allowing pawl 104 to move generally rearward without turning the carrier member. Because the ratcheting motion described above turns the carrier member 130 counterclockwise when viewed from above the head 30, the tool 20 is said to be in a “reverse” configuration when the cam shaft 136 is oriented as shown in FIGS. 5A and 5B, and pawl 104 is referred to as a “reversing pawl.”

When the cam shaft 136 is rotated so the lobe 138 aligns with the finger 134 of pawl 104, the lobe rotates the reversing pawl away from the centerline axis 140 of the carrier wheel 130 so its rack 118 disengages the ratchet teeth 120 of the carrier wheel throughout the entire cyclic motion of the rocker element 102. The rack 118 of the “forwarding pawl” 106 is biased by the torsion spring 132 toward the central axis 140 of the carrier member 130. As the rocking element 102 pivots and pushes the forwarding pawl 106 forward, the rack 118 of the forwarding pawl engages the ratchet teeth 120 of the carrier member 130 and turns the carrier member clockwise. The shapes and angles of the ratchet teeth 120 and the rack 118 of the forwarding pawl 106 push the rack outward and away from a central axis 140 of the carrier member 130 against the biasing force of the torsion spring 132 as the forward pawl moves rearward causing the rack to disengage the ratchet teeth so the carrier member does not turn. When the cam shaft 136 is position so the lobe 138 aligns with the finger 134 of pawl 106, the tool 20 is said to be in a “forward” configuration.

As illustrated in FIG. 2, a selector lever 142 is fastened to an upper end of the cam shaft 136 permitting the user to turn the shaft between the forward and reversed configurations. Further, the lever 142 is conveniently located for the user to use the thumb of the same hand used to grip to tool 20 to turn the cam shaft 136 between the forwarding and reversing configurations. A washer 144 and coil spring 146 maintain the cam shaft 136 in position so the lobe 138 is aligned with the respective finger 134 of pawls 104, 106. In order to prevent pawls 104, 106 from simultaneously engaging the ratchet teeth 120 of the carrier member 130, the lobe 138 of the cam shaft 136 is sufficiently broad enough to separate the racks 118 of both pawls from the carrier member when the selector lever 142 is centered. When configured as described, tool 20 is reversible using of only one hand. Moreover, the tool 20 is reversible by turning the cam shaft 136 even while the rotor 42 is turning without stopping or reversing the motor 40.

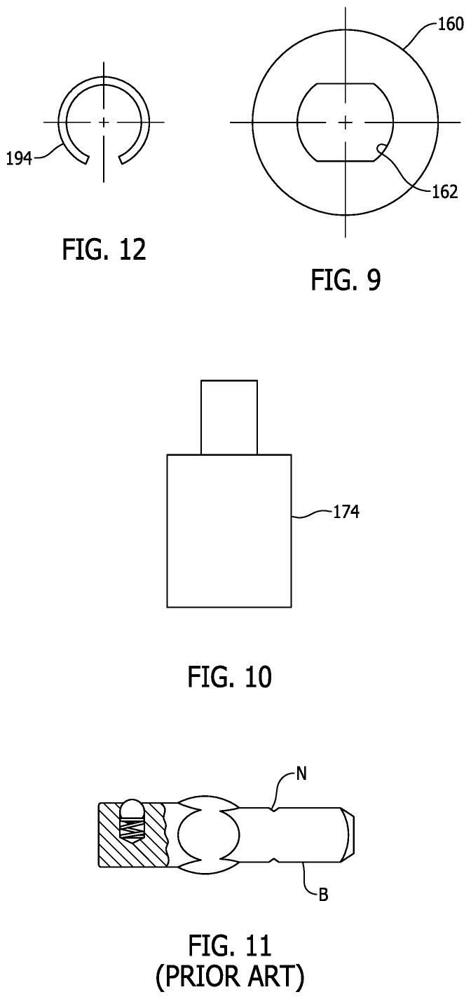

As further shown in FIG. 2 and FIGS. 6-8, the carrier member 130 has a reduced diameter hub 150 at its lower end. A circular port 152 (FIG. 2) in the plate 76 receives the reduced diameter hub 150 holding the carrier member 130 in position while allowing it to freely rotate within the head 30. A shaft 154 having two flat lands 156 extends upward from the upper end of the carrier member 130. The shaft 154 extends through a shoe 160 having an opening 162 shaped as shown in FIG. 9 to correspond with the shaft of the carrier member 130 so the shoe turns with the carrier member. A hardened collar 164 mounted in a counterbored opening 166 in the shell 70 has a central circular hole 168 sized for receiving the shaft 154. Thus, the shaft 154 of the carrier member 130 rotates in the circular hole 168 of the collar 164.

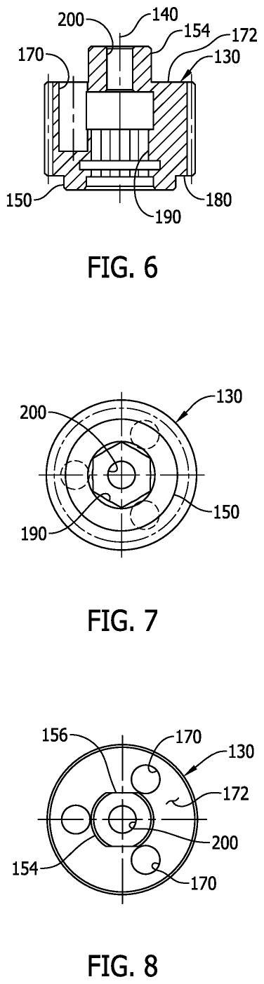

As illustrated in FIGS. 6-8, three equally spaced holes 170 extend downward into the carrier member 130 from an annular boss 172 surrounding the shaft 154. Each hole 170 receives a pusher pin 174 shaped as shown in FIG. 10 and a coil spring 176 (FIG. 2) that biases the pusher pin upward against the shoe 160 to push the shoe against the collar 164 mounted in the shell 70. The coil springs 176 create an equal and opposite reaction force biasing the carrier member 130 downward so the hub 150 remains seated in the corresponding circular port 152 of the plate 76 and annular boss 180 surrounding the hub engages the plate around the opening. As will be appreciated by those skilled in the art, the shoe-and-collar arrangement holds the carrier member 130 from turning as either pawl 104, 106 moves rearward, allowing the respective rack 118 to move outward and pass over the ratchet teeth 120 of the carrier member. When either pawl 104, 106 moves forward while the respective rack 118 is engaged with the ratchet teeth 120, the shoe 160 slides on the collar 164, allowing the carrier member 130 to rotate. The shoe 160 and collar 164 are formed from the same material in some examples. Thus, the shoe 160 and collar 164 tend to wear at a similar rate prolonging their effectiveness in inhibiting rotation of the carrier member 130. As the shoe 160 and collar 164 wear, the springs 176 acting on the pusher pins 174 expand, automatically adjusting for wear.

As further illustrated in FIGS. 6-8 a hexagonal bit receiver opening 190 extends upward into the carrier member 130 for receiving a bit such as a standard quarter-inch hex bit B shown in FIG. 9. Although a conventional quarter-inch hexagonal, socket driver bit B is illustrated, those skilled in the art will appreciate that the drive may include any conventional or conceivable shape including an Allen drive, Bristol drive, a clutch drive, a fluted socket, a Frearson drive, a hex socket, a mortorq drive, a one-way drive, a pentalobe, a Phillips drive, a polydrive, a pozidrive, a quadrex drive, a Robertson drive, a slotted drive, a spanner drive, a spline drive, a supadrive, a torq-set drive, torx drive, a torx socket, or a tri-wing drive, as well as drill bits and thread taps. As shown in FIG. 2, an annular groove 192 formed along the hexagonal receiver opening 190 receives a wire split ring retainer 194 (FIG. 12) for engaging conventional keeper notches N (FIG. 11) provided along the hexagonal shaft of some bits B to retain the bit in the receiver opening 190.

As shown in FIGS. 6-8, a hole 200 extends upward along the central axis 140 of the carrier member 130. A corresponding opening 202 in the shell 70 is aligned with the hole 200 in the carrier member 130. Should a bit B break off or become lodged in the receiver opening 190, a punch (not shown) can be pushed through the opening 202 and hole 200 dislodge the bit.

Other features and advantages of the illustrated tool 20 will be apparent to those skilled in the art. For example, the sealed head 30 prevents debris from entering the head, thereby protecting the internal components from damage and wear, as well as, contains lubricant in the head, rather than allowing lubricant leakage. In addition, those skilled in the art will appreciate that the tool 20 is assembled in a conventional manner and made from conventional materials such as steel and plastics. Although the tool may have other operating parameters, the illustrated tool 20 has a variable working torque ranging from about 4.4 foot-pounds to about 25 foot-pounds, a maximum torque rating of about 25 foot-pounds, and a free speed of about 290 rpm. Further, the illustrated tool 20 has an overall length of about 8 inches and weighs about 1.5 pounds. Although the head 30 of the illustrated tool 20 is vertically centered on and axially aligned with the rotor 42 of the motor 40 and the motor housing 32, those skilled in the art will appreciate the head 30 may be angled or vertically offset from the axes of the rotor and motor housing. Lastly, although the head 30 of the illustrated tool 20 measures about 3.5 inches in length, those skilled in the art will appreciate the head, particularly its low profile portion, may have other lengths. Other variations of the tool are envisioned. For example, the air motor could be replaced by a motor using a different power source. Both an electric and a battery powered electric motor are envisioned. Although the tool described above has a body consisting of a forward housing joined directly to a rearward housing, other configurations are envisioned. For example, the motor and head may be separated by a flexible shaft for transmitting torque from the motor and the head could be formed with a grip for manipulating the head separately from the remote motor.

Having described the drawings in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

One of ordinary skill in the art could make various changes to the above constructions, products, and methods without departing from the scope of the invention as recited in the following claims. Thus, all matter described in the accompanying drawings and the description thereof should be interpreted as illustrative and not in a limiting sense.

What is claimed is:

1. A hand-held power tool for driving bits, said tool comprising:
a body including a forward housing and a rearward housing, said forward housing having a lower surface, a hollow interior, and a port extending through the lower surface to the hollow interior;
a motor mounted in the rearward housing and having an output shaft rotating about a central rotor axis in response to air passing through the motor;
a carrier member rotatably mounted in the hollow interior of the forward housing for rotation about a central turning axis extending generally transverse to the central rotor axis, said carrier member having a bottom surface and a bit receiver opening adapted for releasably receiving bits extending upward along the central turning axis into the carrier member from the bottom surface, said bit receiver opening being aligned with the forward housing port and the bottom surface of the carrier member being flush with the lower surface of the forward housing; and
a pinned linkage operatively connecting the output shaft of the motor to said carrier member to rotate the carrier member about the central turning axis as the output shaft of the motor rotates about the central rotor axis in response to air passing through the motor.

2. A hand-held power tool as set forth in claim 1, wherein said pinned linkage includes a reciprocating pawl that engages the carrier member to rotate the carrier member as the pawl reciprocates.

3. A hand-held power tool as set forth in claim 2, wherein:
the carrier member has ratchet teeth formed around an outward facing surface; and
the pawl is biased toward the carrier member, the pawl includes a rack that engages the ratchet teeth on the carrier member to rotate the carrier member about the central turning axis as the pawl reciprocates.

4. A hand-held power tool as set forth in claim 3, further comprising:
a crank rotatably mounted in the body and operatively connected to the motor output shaft, said crank having an arm that orbits the central rotor axis as the output shaft rotates; and
wherein said pinned linkage includes a rocker element pivotally mounted in the hollow interior of the forward housing, said rocker element being operatively connected to the crank so the rocker cyclically pivots in the hollow interior of the forward housing as the arm of the crank orbits the central rotor axis; and
wherein said pawl is pinned to the rocker element so the pawl reciprocates as the rocker element cyclically pivots in the hollow interior of the forward housing.

5. A hand-held power tool as set forth in claim 4, wherein said pawl is a forwarding pawl and the tool further comprises:
a reversing pawl pinned to the rocker element, so the reversing pawl reciprocates as the rocker element cyclically pivots in the hollow interior of the forward housing, said reversing pawl including a rack that engages the ratchet teeth on the carrier member to rotate the carrier member about the central turning axis as the reversing pawl reciprocates; and
a cam shaft having a lobe positioned between the forwarding pawl and the reversing pawl, said cam shaft being rotatable to selectively position the lobe to separate the respective rack of at least one of the forwarding pawl and the reversing pawl from the ratchet teeth so the carrier member remains stationary as said at least one of the forwarding pawl and the reversing pawl reciprocates.

6. A hand-held power tool as set forth in claim 5, wherein said forwarding pawl and said reversing pawl cross between the rocker element and the carrier member.

7. A hand-held power tool as set forth in claim 4, further comprising:
a collar mounted in the hollow interior of the forward housing; and
a shoe that rotates with the carrier member and contacts the collar to hold the carrier member against rotation as the reciprocating pawl moves in a first direction, said shoe slides on the collar permitting the carrier member to rotate as the reciprocating pawl moves in a second direction opposite said first direction and the rack of the pawl engages the ratchet teeth on the carrier member to rotate the carrier member about the central turning axis.

8. A hand-held power tool as set forth in claim 1, wherein the bit receiver opening is hexagonal and sized to receive a ¼ inch bit.

9. A hand-held power tool as set forth in claim 1, further comprising an annular retainer positioned in the bit receiver opening for engaging bits when received in the receiver opening to retain the bits in the receiver opening.

10. A hand-held power tool as set forth in claim 1, wherein at least a portion of the lower surface of the forward housing is planer and the forward housing has an upper planar surface spaced from the lower surface by a distance less than 0.75 inches.

11. A hand-held power tool for driving bits, said tool comprising:
a body including a forward housing and a rearward housing, said forward housing having a lower surface, a hollow interior, and a port extending through the lower surface to the hollow interior;
a motor mounted in the rearward housing and having an output shaft rotating about a central rotor axis;
a carrier member rotatably mounted in the hollow interior of the forward housing for rotation about a central turning axis extending generally transverse to the central rotor axis, said carrier member having ratchet teeth formed around an outward facing surface, a bottom surface and a bit receiver opening adapted for releasably receiving bits extending upward along the central turning axis into the carrier member from the bottom surface, said bit receiver opening being aligned with the forward housing port;
a reciprocating pawl including a rack that engages the ratchet teeth on the carrier member to rotate the carrier member about the central turning axis as the pawl moves forward.

12. A hand-held power tool as set forth in claim 11, further comprising:
a collar mounted in the hollow interior of the forward housing; and
a shoe that rotates with the carrier member and contacts the collar to hold the carrier member against rotation as the reciprocating pawl moves rearward causing the rack to pass over the ratchet teeth while the carrier member is held against rotation, said shoe slides on the collar permitting the carrier member to rotate as the reciprocating pawl moves forward with the rack of the pawl engaging the ratchet teeth on the carrier member to rotate the carrier member about the central turning axis.

13. A hand-held power tool as set forth in claim 12, further comprising a spring positioned between the carrier member and shoe to bias the shoe against the collar.

14. A hand-held power tool as set forth in claim 12, further comprising a crank rotatably mounted in the body and operatively connected to the motor output shaft, said crank having an arm that orbits the central rotor axis as the output shaft rotates; and
wherein said pinned linkage includes a rocker element pivotally mounted in the hollow interior of the forward housing, said rocker element being operatively connected to the crank so the rocker cyclically pivots in the hollow interior of the forward housing as the arm of the crank orbits the central rotor axis; and
wherein said pawl is pinned to the rocker element so the pawl reciprocates as the rocker element cyclically pivots in the hollow interior of the forward housing.

15. A hand-held power tool as set forth in claim 14, wherein said pawl is a forwarding pawl and the tool further comprises:
a reversing pawl pinned to the rocker element, so the reversing pawl reciprocates as the rocker element cyclically pivots in the hollow interior of the forward housing, said reversing pawl including a rack that engages the ratchet teeth on the carrier member to rotate the carrier member about the central turning axis as the reversing pawl reciprocates; and
a cam shaft having a lobe positioned between the forwarding pawl and the reversing pawl, said cam shaft being rotatable to selectively position the lobe to separate the respective rack of at least one of the forwarding pawl and the reversing pawl from the ratchet teeth so the carrier member remains stationary as said at least one of the forwarding pawl and the reversing pawl reciprocates.

16. A hand-held power tool as set forth in claim 15, wherein said forward housing and said rearward housing are joined.

17. A hand-held power tool for driving bits, said tool comprising:
a body including a forward housing and a rearward housing, said forward housing having a lower surface, a hollow interior, and a port extending through the lower surface to the hollow interior;
a motor mounted in the rearward housing and having an output shaft rotating about a central rotor axis in response to air passing through the motor;
a crank rotatably mounted in the body and operatively connected to the motor output shaft, said crank having an arm that orbits the central rotor axis as the output shaft rotates;
a rocker element pivotally mounted in the hollow interior of the forward housing, said rocker element being operatively connected to the crank so the rocker oscillates in the hollow interior of the forward housing as the arm of the crank orbits the central rotor axis;
an elongated pawl is pinned to the rocker element, so the pawl reciprocates in a generally lengthwise direction as the rocker element oscillates in the hollow interior of the forward housing; and
a carrier member rotatably mounted in the hollow interior of the forward housing for rotation about a central turning axis extending generally transverse to the central rotor axis, said carrier member having a bottom surface and a bit receiver opening adapted for releasably receiving bits extending upward along the central turning axis into the carrier member from the bottom surface, said bit receiver opening being aligned with the forward housing port; and
wherein the reciprocating pawl engages the carrier member to rotate the carrier member as the pawl reciprocates.

18. A hand-held power tool as set forth in claim 17, wherein:
the carrier member has ratchet teeth formed around an outward facing surface; and
the pawl includes a rack that engages the ratchet teeth on the carrier member to rotate the carrier member about the central turning axis as the pawl reciprocates.

19. A hand-held power tool as set forth in claim 18, further comprising:
a collar mounted in the hollow interior of the forward housing; and
a shoe that rotates with the carrier member and contacts the collar to hold the carrier member against rotation as the reciprocating pawl moves rearward causing the rack to pass over the ratchet teeth while the carrier member is held against rotation, said shoe slides on the collar permitting the carrier member to rotate as the reciprocating pawl moves forward with the rack of the pawl engaging the ratchet teeth on the carrier member to rotate the carrier member about the central turning axis.

20. A hand-held power tool as set forth in claim 18, wherein said pawl is a forwarding pawl and the tool further comprises:
a reversing pawl pinned to the rocker element so the reversing pawl reciprocates as the rocker element oscillates in the hollow interior of the forward housing, said reversing pawl including a rack that engages the ratchet teeth on the carrier member to rotate the carrier member about the central turning axis as the reversing pawl reciprocates; and
a cam shaft having a lobe positioned between the forwarding pawl and the reversing pawl, said cam shaft being rotatable to selectively position the lobe to separate the respective rack of at least one of the forwarding pawl and the reversing pawl from the ratchet teeth so the carrier member remains stationary as said at least one of the forwarding pawl and the reversing pawl reciprocates.
